(19) United States
(12) Patent Application Publication
(10) Pub. No.: US 2005/0030529 A1
(43) Pub. Date: Feb. 10, 2005

(54) Sensor for detecting filth and/or humidity on the outer side of a glass pane

(76) Inventors: Thomas Schuler, Wiernsheim (DE); Tobias Schuhmacher, Vaihingen-Horrheim (DE)

Correspondence Address: Andrew R Basile;Young & Basile, Suite 624, 3001 West Big Beaver Road, Troy, MI, 48084, US

(21) Appl. No.: 10/473,908

(22) PCT Filed: Mar. 16, 2002
(86) PCT No.: PCT/EP02/02935

(30) Foreign Application Priority Data
Apr. 6, 2001 (DE) 10117397.0

(51) Int. Cl. G01N 21/88

(52) U.S. Cl. 356/239.8

(57) ABSTRACT

A sensor and a method for detecting humidity drops on the outer side of a glass pane of a motor vehicle. The sensor has several transmitting elements assembled into two transmitting branches that are jointly connected to at least one optical receiving element in a control circuit. The control circuit regulates the transmitting power of the transmitting elements in each branch so that the luminous power of the optical beams received by the receiving element and the luminous power of the optical beams transmitted by the transmitting elements of both transmission branches are equally high. The sensor has a control for storing initial values for the control signals of the transmitting elements before operation of the sensor and detecting static deviation from the difference between the actual value of the control signals and the initial value during operation of the sensor.

### BACKGROUND

The present invention relates to a sensor for detecting dirt and/or moisture on an outer side of an optically permeable body. The sensor is located on the inside of the body and has several optical transmitting elements and at least one optical receiving element. The transmitting elements are combined into at least two transmitting branches, which, together with the at least one receiving element, are connected in a feedback control circuit. The feedback control circuit varies the transmitting power of the transmitting elements by branch with the aim of regulating the light output of the beams received by the receiving elements and emitted by the at least one transmitting element of the first transmitting branch and reflected on the outside of the optically permeable body to be the same as the light output of the reflected beams received by the receiving elements and emitted by the at least one transmitting element of the second branch.

The invention further relates to a procedure for operating a sensor for detecting dirt and/or moisture on an outside of an optically permeable body. The sensor has several optical transmitting elements and at least one receiving element. As part of this procedure, the transmitting elements are combined into at least two transmitting branches which, together with the at least one receiving element are connected in a feedback control circuit. Through the feedback control circuit, the transmitting power of the transmitting elements is varied by branch with the aim of regulating the light output of the beams received by the receiving element and transmitted by the at least one transmitting element of the first branch and reflected at the outside of the optically permeable body to be the same as the light output of the beams received by the receiving element and transmitted by the at least one transmitting element of the second branch.

The present invention further relates to a memory element for a control unit of a sensor for detecting dirt and/or moisture on an optically permeable body. A computer program is stored on the memory element, which program can be run on a computer, specifically on a microprocessor. In particular, a read-only memory, a random-access memory or a flash-memory can be employed as the memory element.

Finally the invention relates to a control unit for a sensor for detecting dirt and/or moisture on an optically permeable body. The control unit comprises a computer, specifically a microprocessor, and a memory element. The sensor has several optical transmitting elements and at least one receiving element, where the transmitting elements are combined into at least two transmitting branches which, together with the at least one receiving element, are connected in a feedback control circuit. The feedback control circuit varies the transmitting power of the transmitting elements by branch with the aim of regulating the light output of the beams received by the receiving elements and emitted by the at least one transmitting element of the first transmitting branch and reflected at the outside of the optically permeable body to be the same as the light output of the reflected beams received by the receiving elements and emitted by the at least one transmitting element of the second branch.

Sensors of the type named at the beginning are known from the automobile world in different embodiments for detecting raindrops on the outside of a vehicle window. The transmitting elements of the known sensors are aligned in such a way that a majority of the optical beams emitted by the transmitting elements are reflected to the receiving elements when there are no drops of moisture on the outside of the glass. The optical beams emitted by the transmitting elements are at least partially deflected out of the glass when they encounter drops of moisture on the outside of the glass and thus do not strike the receiving element.

With the known sensors, several transmitting elements are normally combined in two transmitting branches. The transmitting elements of the two transmitting branches are alternately energized with square-wave pulses at a frequency of about 31 kHz and they alternately transmit matching optical beams in the infra-red (IR) frequency. A receiving element is furnished, which alternately receives light beams which were emitted by the transmitting elements of the first branch and light beams which were emitted by the transmitting elements of the second branch (synchronous demodulation). A difference is formed between both branches from their respective signals. The differential signal is evaluated by a suitable receiving circuit. The receiving circuit generates a pulse-width modulated signal which contains information about the size and number of the rain drops on the outside of the glass.

The receiving circuit and the activation for the two transmitting branches are connected in a feedback control circuit. The feedback control circuit varies the transmitting power of the transmitting elements by branch with the aim of regulating the light output of the beams received by the receiving elements and emitted by the at least one transmitting element of the first transmitting branch and reflected at the outside of the optically permeable body to be the same as the light output of the reflected beams received by the receiving elements and emitted by the at least one transmitting element of the second branch. The control system is used to correct for interference with rain detection. Interference can be caused by scratches on the glass or aging of the electrical components in the sensor. The control system for the light output is relatively slow (about 4 Hz), so that on the one hand slow dynamic changes are corrected, but on the other hand rapid dynamic changes caused by rain drops on the glass can still be detected. The effects of the control system are that the sensor is always being operated at its operating point, which increases precision and reliability of detection.

The disadvantage of the known sensor is that events with a very low dynamic, which can almost be described as static events, such as for example, a layer of dirt forming on the glass over a period of minutes, hours or even days, can be corrected for through the control system and therefore cannot be detected.

### SUMMARY

The object of the present invention is to create a potential for reliable detection of even events with a very low dynamic, using a sensor of the type described at the beginning.

To achieve this objective, the invention proposes, using the sensor of the type described at the beginning as a departure point, that the sensor has means to store initial values for activation signals for the transmitting elements before operation of the sensor and means to determine a static deviation during operation of the sensor from the difference between the current values for the activation signals and the stored initial values.

The sensor in accordance with the invention comprises several transmitting elements combined into transmitting branches and at least one receiving element which receives the optical beams emitted by the transmitting elements and reflected at the outside of the body. The activation of the transmitting elements and the receiving electronics are part of a feedback control circuit to regulate the output of the received light beams by varying the activation signals for the transmitting elements. Events with a slow dynamic (e.g. effects of component aging or effects of scratches on the optically permeable body) are corrected for through this regulation.

With the sensor according to the invention, the initial values for the activation signals are read and stored before operation of the sensor. During operation of the sensor, slow dynamic changes occur which are corrected for. Toward the outside, the light output of the light beams received by the transmitting branches remains essentially constant in spite of interference, except for dynamic deviation. Dynamic deviation, however, is corrected for within a short time. In order to retain the light output of the transmitting branches at an essentially equal level in spite of the different effects of interference on the transmitting branches, the transmitting elements of the branches are activated with different signals. So internally the outcome is a static deviation which results from the difference between the stored initial values and the current values of the activation signals. Under the invention, the static deviation is adduced to detect very slow dynamic events. Static deviation allows a reliable statement about the presence of very slow events.

During sensor operation it may be necessary from time to time to store new initial values for the activation signals, i.e. to calibrate the sensor. In this way, scratches on the optically permeable body or component aging, which also result in static deviation, are prevented from causing improper detection of dirt particles on the outside of the body. The effects of scratches or component aging on the light output of the beams received are taken into consideration in the newly stored initial values.

The sensor can be calibrated either at regular intervals or as events demand. If, for example, various measures to clean and/or dry a window of a vehicle (e.g. wiping, spraying, intensive cleaning, etc.) remain unsuccessful, the static deviation determined could have its origin not in soiling of the glass but, for example, in scratches on the glass or in aging of sensor components. Calibrating the sensor can provide a remedy in such a situation.

In accordance with an advantageous improvement to the present invention, it is proposed that at least one transmitting element of the first branch is aligned in such a way that a majority of the optical beams emitted by the transmitting element is reflected to the at least one receiving unit without drops of moisture on the outside of the body, and at least one transmitting element of the second branch is aligned in such a way that a majority of the optical beams emitted by the additional transmitting element is deflected at the outside of the body without dirt particles on the outside of the body. In accordance with this improvement to the inventive sensor, one part of the transmitting elements of the first branch serves to detect drops of moisture on the outside of the glass and another part of the transmitting elements of the second branch serves to detect very slow dynamic events, such as for example, dirt accumulation on the outside of a glass.

In accordance with a preferred aspect of the invention, it is proposed that when the optical beams emitted by the at least one transmitting element encounter drops of moisture on the outside of the body, they are at least partially deflected out of the body.

In accordance with a further aspect of the invention, it is proposed that when the optical beams emitted by the at least one additional transmitting element encounter a dirt particle on the outside of the body, they are at least partially reflected on the outside of the body onto the at least one receiving element.

Advantageously those transmitting elements are combined in the first branch which are aligned in such a way that a majority of the optical beams emitted by these transmitting elements are reflected onto the at least one receiving element without drops of moisture on the outside of the body, and the additional transmitting elements are combined in the second transmitting branch which are aligned in such a way that a majority of the optical beams emitted by the additional transmitting elements are deflected out of the body without dirt particles on the outside of the body. Accordingly, those transmitting elements which serve to detect drops of moisture are grouped in the first transmitting branch and those transmitting elements which serve to detect dirt particles are grouped in the second branch.

In order to have a closed feedback control circuit in the second transmitting branch even with a clean glass with no dirt particles on the glass, light beams from at least one of the transmitting elements of the second branch should reach the receiving element, even with clean glass. It is proposed that at least one additional transmitting element is provided in the second branch which is aligned in such a way that a portion of the optical beams emitted by the additional transmitting element is reflected onto the at least one receiving element without dirt particles on the outside of the body. The light beams from the remaining transmitting elements of the second branch are for the most part deflected out of the body with clean glass.

In accordance with another advantageous improvement to the present invention, it is proposed that the transmitting elements, individually or in multiples, emit optical beams in sequence, and each receiving element, synchronously to the emission of the optical beams by the transmitting elements, receives beams reflected at the outside of the optically permeable body and takes them for evaluation. Sensor operation with one receiving element, which is toggled for the alternate reception of light beams from the transmitting elements of the first branch and of light beams from the transmitting elements of the second branch synchronously with the transmission of the light beams by the transmitting elements, is described as synchronous modulation.

As a further way to achieve the object of the present invention, it is proposed, starting with the procedure of the type named at the beginning, that before sensor operation begins, initial values for activation signals for the transmitting elements are stored and during sensor operation a static deviation is determined from the difference between the current values for the activation signals and the initial values.

Of special importance is the implementation of the inventive procedure in the form of a memory element which is provided for a control unit of a sensor for detecting dirt and/or moisture on an optically permeable body, specifically on a glass of a motor vehicle. A computer program is stored on the memory element, the program being executable on a computer, particularly on a microprocessor and is suitable for performing the procedure in accordance with the invention. In this case, the invention is realized by a program stored on the memory element, so that this memory element provided with the computer program represents the invention in the same way as the procedure which the program is suited to perform. In particular, an electrical storage medium can be used as the memory element, for example, a read-only memory, a random-access memory or a flash-memory.

Finally, as yet another way of achieving the object of the present invention it is proposed, starting from the control unit of the type at the beginning described above, that the control unit has means to store initial values for actuation signals for the transmitting elements before sensor operation and means to determine static deviation during sensor operation from the difference between the current values for the actuation signals and the initial values.

In accordance with an advantageous improvement of the present invention, it is proposed that a computer program is stored on the memory element which can be run on the computer and is suitable for carrying out the procedure under the invention.

### BRIEF DESCRIPTION OF THE DRAWING

Additional features, potential applications and advantages of the invention can be found in the description to follow of embodiments of the invention which are shown in the drawing. All the features described or represented in themselves or in any combination form the subject of the invention, independently of their summation in the patent claims or its prior references and independently of their formulation or representation in the description or drawing.

In the drawing:

FIG. 1 shows a plan view in cross-section of a sensor in accordance with the invention for detecting drops of moisture and dirt particles on the outside of an automobile window when the glass is dry and clean;

FIG. 2 shows a frontal view of a sensor in accordance with the invention;

FIG. 3 shows the path of the beams from a transmitting element of the sensor from FIG. 1 for detecting drops of moisture with dry glass;

FIG. 4 shows the path of the beams from the transmitting element from FIG. 1 with wet glass;

FIG. 5 shows the path of the beams from a transmitting element of the sensor from FIG. 1 for detecting dirt particles with clean glass;

FIG. 6 show the path of the beams from the transmitting element from FIG. 1 with dirty glass;

FIG. 7 is a wiring diagram for a control system as implemented in a procedure according to the invention for detecting drops of moisture and dirt particles on the outside of a vehicle window with dry, clean glass;

FIG. 8 is a flow chart of the procedure according to the invention;

FIG. 9 shows a simple evaluation algorithm for processing initial signals from the sensor; and

FIG. 10 shows a control unit for a sensor in accordance with FIG. 1.

### DETAILED DESCRIPTION

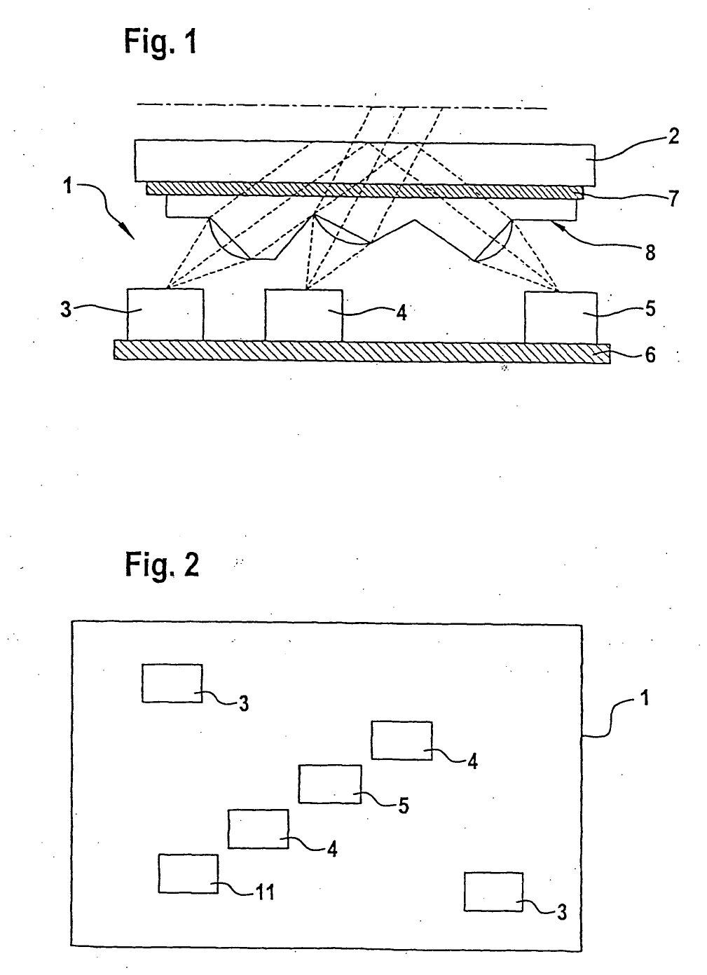

In FIG. 1 a sensor in accordance with the invention for detecting drops of moisture and dirt particles on the outside of a vehicle window is identified in general with the reference numeral 1. The glass is identified by the reference numeral 2 and can be any window, specifically a windshield or a rear window. The sensor 1 comprises several transmitting elements 3, 4, of which only two are shown in FIG. 1, and a receiving element 5, which receives optical beams emitted by the transmitting elements 3, 4 and reflected from the outside of the glass 2. The transmitting elements 3, 4 are configured as light-emitting diodes (LEDs) which emit optical beams in the infra-red (IR) frequency range. The IR diodes have a angle of radiation of +/−60°.

The transmitting elements 3, 4 and the receiving element 5 are attached to a printed circuit board (PCB) 6 and are integrated into the electrical circuit of the sensor 1. An optical adhesive strip 7 is positioned on the inside of the glass 2, and on the strip in turn there is an optical module 8 by means of which the beams emitted by the transmitting elements 3, 4 are collimated so that more beams strike the receiving element 5 and the luminous intensity of the reception signal is greater. The adhesive strip 7 acts as a coupling element and has approximately the same refractive index as the glass of the window 2 so that light beams do not undergo any additional refraction as they pass from the adhesive strip into the window 2. The inventive sensor 1 also functions without the optical module 8 shown in FIG. 1.

The sensor 1 of the invention can detect rain and dirt on the glass pane. Depending on an initial signal from the sensor 1 or the evaluation electronics connected to it, the wiper and/or washer system for the glass 2 is activated automatically. Safety in a vehicle can be decisively improved through the sensor 1 since any obstruction to vision from rain, ice, snow or dirt can be promptly detected and automatically removed promptly and effectively.

The sensor 1 under the invention is configured as an on-the-glass sensor which is attached directly to the inside of the glass 2, without any air gaps between the transmitting/receiving elements 3, 4, 5 and the glass 2. This prevents any negative effect from a glass 2 that is fogged up on the inside. There is no need for an optical module 8, which results in cost savings. The electronics to evaluate the initial signals from the sensor 1 are mounted directly on the sensor 1 and they are attached to the glass 2 together with the sensor 1.

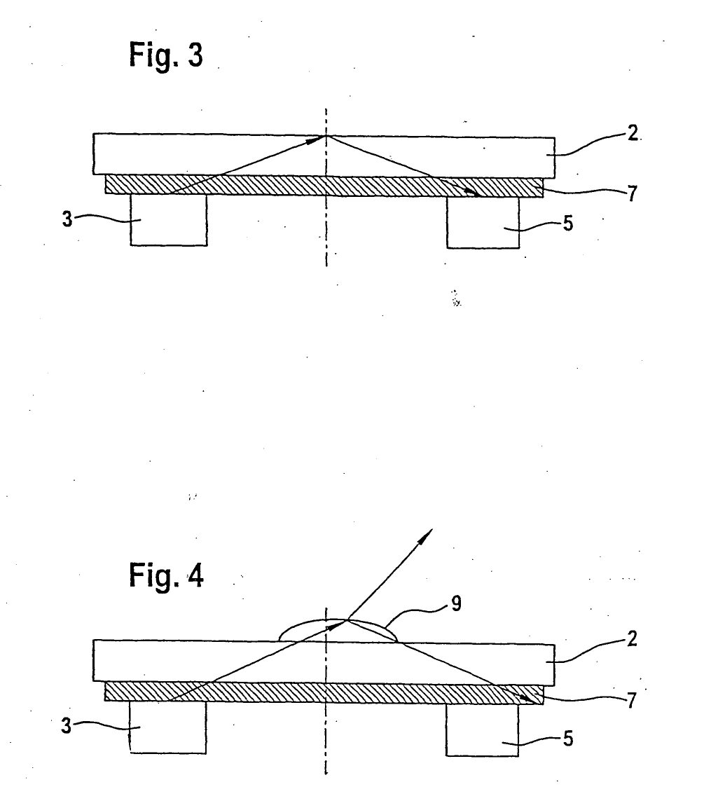

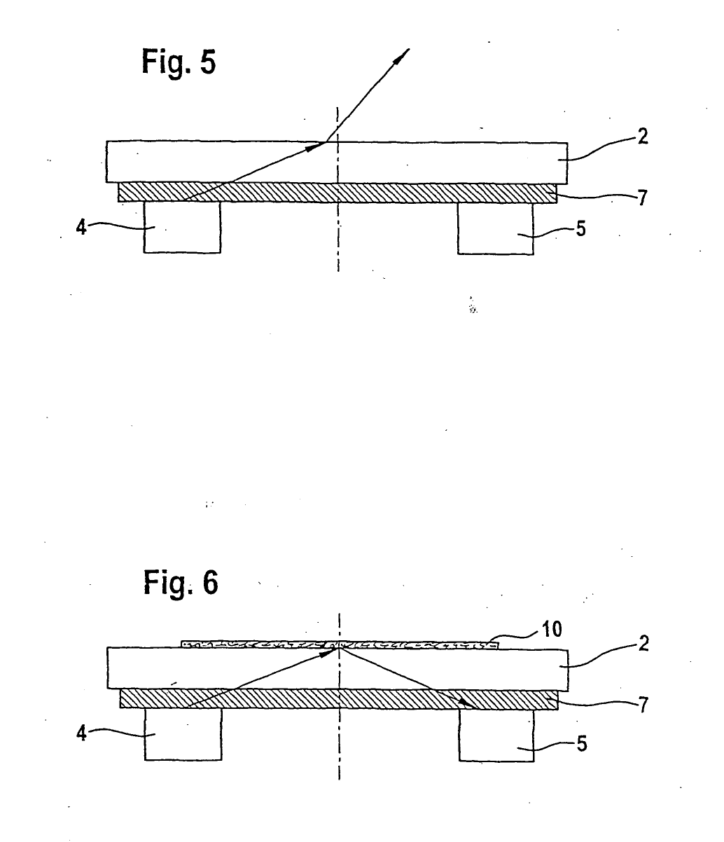

It can be clearly seen in FIG. 1 that the light beams emitted by the transmitting element 3 are mostly reflected to the receiving element 5 when the glass 2 is dry and clean (See FIG. 3). However, if a drop of moisture 9 is present on the outside of the glass 2 (See FIG. 4), a portion of the light beams emitted by the transmitting element 3 is deflected at the outside of the drop 9 or reflected in such a way that the reflected light beams do not strike the receiving element 5. It can also be seen in FIG. 1 that the light beams emitted by the transmitting element 4 are for the most part deflected out of the glass at the outside of the glass 2 and do not strike the receiving element 5 (See FIG. 5). However, if there is film of dirt on the outside of the glass 2 consisting of a plurality of dirt particles 10 (See FIG. 6), a majority of the light beams emitted by the transmitting element 4 is reflected at the outside of the glass 2 onto the receiving element 5. The transmitting element 3 thus serves to detect drops of moisture on the glass 2, and the transmitting element 4 serves to detect dirt particles on the glass 2.

FIG. 2 is a front view of the sensor 1 with an example of the arrangement of the transmitting/receiving elements 3, 4, 5. The transmitting elements 3 are combined into a first transmitting branch, and the receiving elements 4 are combined into a second transmitting branch with an additional transmitting element 11. The distance of the transmitting elements for detecting rain from the receiving element 5 is calculated using the law of reflection. The distance of the transmitting elements 4 for detecting dirt from the receiving element 5 is shorter so that the reflected light beams do not strike the receiving element 5 when the glass 2 is clean. The transmitting element 11 is at a slightly shorter distance than the reflection distance from the receiving element 5. As a result, a certain portion of the beams is reflected to the receiving element 5 from the transmitting element 11 even when the glass 2 is clean and dry.

The transmitting power of the transmitting elements 3, 4, 11 is varied in the evaluation electronics of the sensor 1 in such a way that the strength of the optical beams emitted by the transmitting elements 3 of the first branch and received at the receiving element 5 is the same as the strength of the optical beams emitted by the transmitting elements 4, 11 of the second branch and received at the receiving element 5. So the transmitting power of the transmitting elements 3, 4, 11 is regulated in such a way that the received light output of the first branch is the same as the received light output of the second branch. A difference (dynamic deviation) is created between the two branches from the signals received. The difference arises from the effect of the rain drops 9 or the dirt particles 10 on the glass and is corrected for by the control system. As long as there is dynamic deviation, the initial signal is generated. Depending on the initial signal, a pulse-width and frequency-modulated (PWM) signal is generated which is dependent on the number and size of the rain drops 9. By regulating output, the effects of slowly changing interference signals, for example due to aging of components or scratches on the glass, can be corrected for. The sensor 1 is thus always operated at its operating point. The additional transmitting element 11 serves to close the feedback control circuit through the actuating circuits of the transmitting elements 4, 11 of the second branch and the receiving element 5 when the glass 2 is clean and dry.

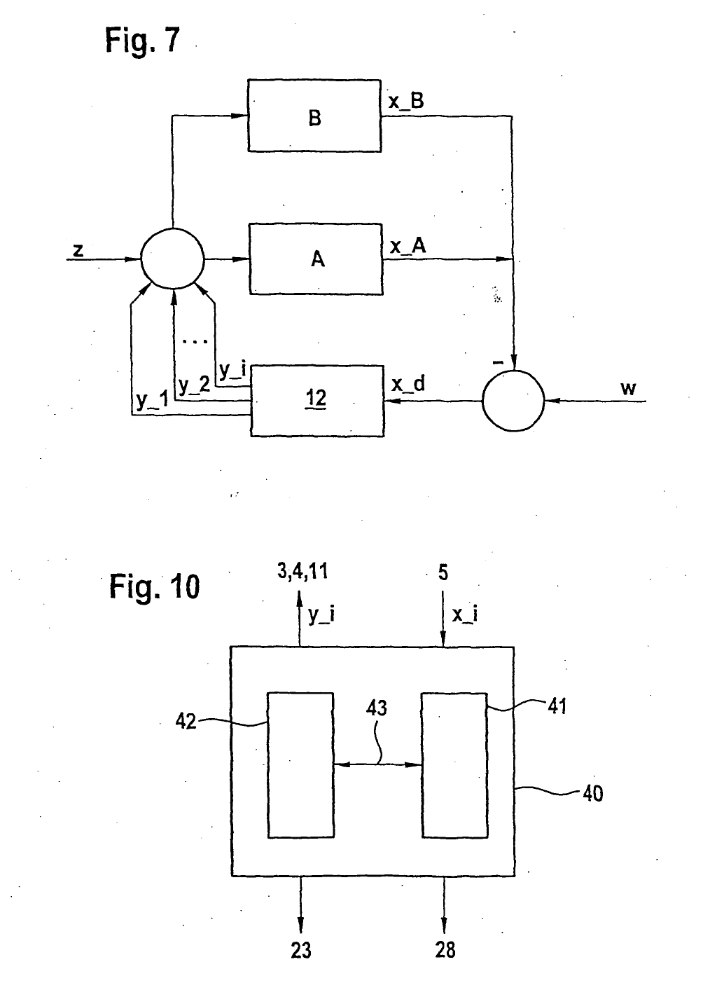

The transmitting power of the transmitting elements 3, 4, 11 can be varied by means of a control signal (See correction variable y_i in FIG. 7) for the transmitting elements 3, 4, 11, specifically through the control current. In the case of the inventive sensor 1, a static deviation x_d_stat is determined in addition to the regulation of output described above. Before the sensor 1 begins operation, the initial values for the control signals y_i_anf for the transmitting elements 3, 4, 11 are stored. During operation of the sensor 1, the current values of the control signals y_i are determined and the difference to the stored values y_i_anf is created. The difference y_i_anf−y_i corresponds to the static deviation x_d_stat. As long as a static deviation is present or as long as the static deviation exceeds a limit which can be specified, an initial signal is generated. Depending on the initial signal, an additional pulse-width and frequency modulated (PWM) signal is generated which is dependent (among other things) on the number and size of the dirt particles 10. In the case of the sensor 1 according to the invention, the control current for the transmitting elements 3, 4, 11 necessary for the readjustment of the feedback control circuit is adduced as a measure for the interference variables z affecting the feedback control circuit.

The wiring diagram for the corresponding feedback control circuit is shown in FIG. 7. The optical segments (control segments) of the transmitting branches are identified by A and B. The light output (control variable) is identified with x_A or x_B. The command variable is identified by w. The dynamic deviation as the difference between specified value w and actual value x_A, x_B is identified with x_d. A controller 12 performs the regulating function for light output x_A=x_B. The initial signal of the regulator 12 is different control currents y_i (correction variable), which affect the transmitting elements 3 or 4, 11 for the branches A or B. Different interference variables z also affect the transmitting branches A, B.

From time to time or as events dictate (for example, when specific cleaning steps do not have the desired effect), it may be necessary to store new initial values for the control signals, i.e. to calibrate the sensor 1. This prevents scratches on the glass 2 or aging of the sensor 1 components from causing incorrect detection of dirt particles 10 on the outside of the glass 2. It is also conceivable to supplement the sensor 1 with a temperature sensor (not shown) and to adduce the initial temperature sensor signal in the evaluation and processing of the initial signals of the sensor 1. A thermal element, a PT 100 or a semi-conductor component is particularly suitable as a temperature sensor. With the help of the temperature sensor, ice and snow can be detected on the glass 2 and suitable steps taken to remove them.

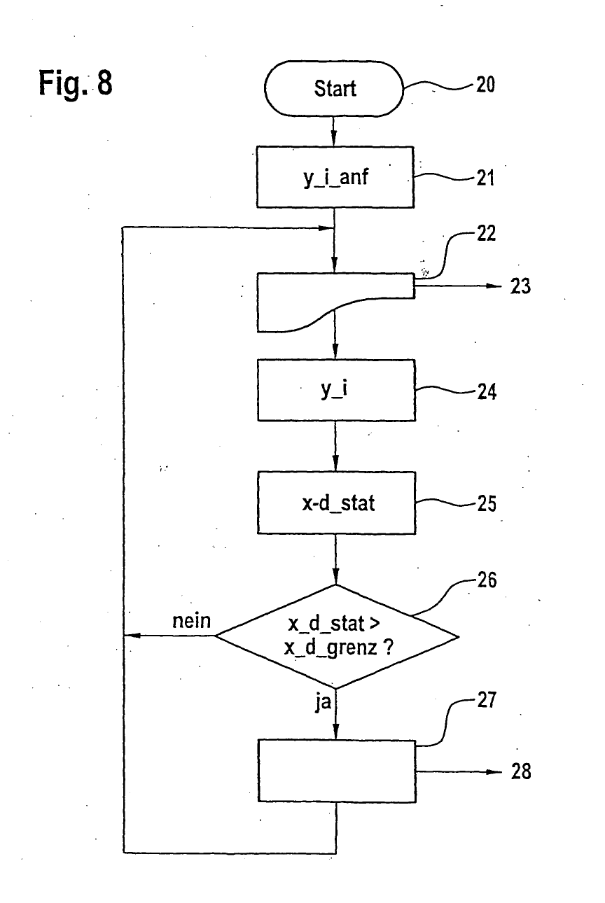

FIG. 8 shows a flow chart of the procedure in accordance with the invention. It starts in a functional block 20. Before the sensor 1 starts operation, initial values y_i-anf for the control signals y_i for the transmitting elements 3, 4, 11 are stored in a functional block 21. Then the regulation of light output described above is carried out in a functional block 22. Through a suitable algorithm, the pwm-signal 23, which is dependent on the number and size of the rain drops 9, is generated and issued. Then during operation of the sensor 1, the current values for the control signals y_i are read in a functional block 24. Then the static deviation x_d_stat is determined in block 25 from the difference between the initial values y_i_anf and the current values y_i of the control signals. In an interrogation block 26, a check is made whether the static deviation x_d_stat that was determined is above a limit x_d_grenz that can be specified. If not, the procedure branches to functional block 22 again and it is continued there. Otherwise, the additional pwm-signal which is dependent on the number and size of the dirt particles 10 is generated and issued in a functional block 27 using a suitable algorithm. Then the procedure branches to functional block 22 and is continued there.

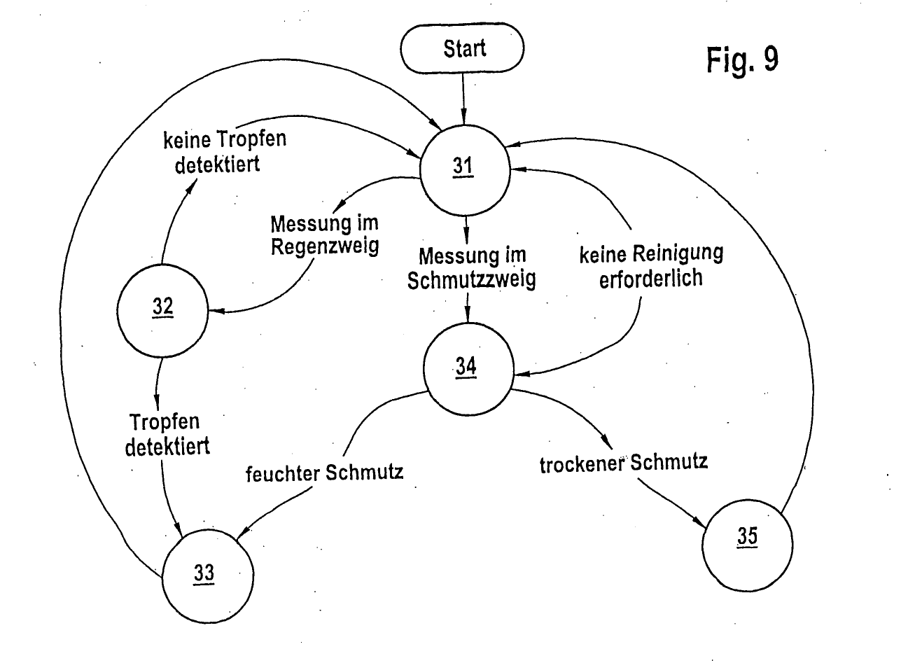

FIG. 9 shows an example of an evaluation algorithm for the initial signal of the sensor 1 using a phase state diagram. The algorithm starts in a state 30 and then changes to a state 31 in which the sensor 1 starts to measure. For a measurement in the first transmitting branch, there is a change to a state 32 in which the outside of the glass 2 is examined for drops of moisture 9. If no drops 9 are detected, there is a change from state 32 back to state 31 again. Otherwise there is a change from state 32 to a state 33 in which the glass 2 is wiped. After the glass is wiped, the algorithm changes back again to state 31.

For a measurement in the second transmitting branch, there is a change to a state 34 in which the outside of the glass 2 is examined for drops of moisture 9 and dirt particles 10. If no dirt particles 10 are detected, a change takes place from state 34 to state 31 again. If damp dirt particles 10 are detected on the glass 2, there is a change from state 34 to state 33 in which the glass 2 is wiped. After the glass has been wiped, the algorithm changes to state 31 again. If dry dirt particles 10 are detected on the glass 2, there is a change from state 34 to a state 35 in which the glass 2 is washed and wiped. After the glass is washed and wiped, the algorithm changes to state 31 again.

In FIG. 10, a control unit in accordance with the invention is identified in general with the reference numeral 40. The intention of the control unit 40 is for the sensor 1 to detect drops of moisture 9 and dirt particles 10 on the glass 2. The control unit 40 comprises a computer 41, specifically a microprocessor, and a memory element. The memory element is preferably configured as a flash memory. A computer program suitable for performing the procedure in accordance with the invention which can be run on the computer 41 is stored on the memory element. To run the computer program, it is transmitted over a data link 43 either in its entirety or in sections or by command from the memory element 42 to the computer 41. The control unit 40 receives signal x_i from the receiving element 5 which corresponds to the light output of the light beams received from the branches A, B. Depending on the signal x_i received, control signals y_i are generated for the transmitting elements 3, 4, 11 and issued to them or to end stages for the transmitting elements 3, 4, 11. The control unit 40 also issues the pwm-signals 23 and 28 which contain information about the number and size of drops of moisture 9 and dirt particles 10 detected on the glass 2.

1. A sensor for detecting dirt and/or moisture on an outside of an optically permeable body, where the sensor is located on the inside of the body and has a plurality of optical transmitting elements and at least one optical receiving element and the transmitting elements are combined into at least two transmitting branches which, together with the at least one receiving element, are connected in a feedback control circuit which varies the transmitting power of the transmitting elements by branch with the aim of regulating the light output of the beams received by the receiving element, emitted by the at least one transmitting element of the first transmitting branch and reflected at the outside of the optically permeable body to be the same as the light output of the reflected beams received by the receiving element, emitted by the at least one transmitting element of the second transmitting branch, characterized in that the sensor has means for storing initial values for control signals for the transmitting elements before operation of the sensor and means to determine a static deviation during operation of the sensor of a difference between the current values for the control signals and the stored initial values.

2. The sensor as set forth in claim 1, wherein at least one transmitting element of the first transmitting branch is aligned in such a way that a majority of the optical beams emitted by the transmitting element is reflected at the outside of the body to the at least one receiving element without drops of moisture, and at least one transmitting element of the second transmitting branch (B) is aligned in such a way that a majority of the optical beams emitted by the additional transmitting element (4) is deflected at the outside out of the body (2) without dirt particles (10) on the outside of the body (2).

3. The sensor as set forth in claim 2, wherein the optical beams emitted by the at least one transmitting element are at least partially deflected out of the body when they encounter drops of moisture on the outside of the body.

4. The sensor as set forth in claim 2, wherein the optical beams emitted by the at least one additional transmitting element are at least partially reflected at the outside of the body to the at least one receiving element when the optical beams encounter dirt particles on the outside of the body.

5. The sensor as set forth in claim 2, wherein those transmitting elements are combined in the first transmitting branch which are so aligned that a majority of the optical beams emitted by these transmitting elements is reflected without moisture drops on the outside of the body to the at least one receiving element, and the additional transmitting elements are combined in the second transmitting branch which are so aligned that a majority of the optical beams emitted by the additional transmitting elements is deflected out of the body at the outside without dirt particles on the outside of the body.

6. The sensor as set forth in claim 5, wherein at least one additional transmitting element is furnished in the second transmitting branch which is aligned in such a way that a portion of the optical beams emitted by the additional transmitting element is reflected at the outside of the body to the at least one receiving element.

7. The sensor as set forth in claim 1, wherein the transmitting elements emit optical beams individually or in groups in succession and the or each receiving element, synchronously with the emission of the optical beams by the transmitting elements, receives beams reflected at the outside of the optically permeable body and transfers the received beams for evaluation.

8. A method for operating a sensor for detecting dirt and/or moisture on an outside of an optically permeable body, wherein the sensor has a plurality of optical transmitting elements and at least one receiving element comprising the steps of:
combining the transmitting elements into at least two transmitting branches;
connecting the two transmitting branches with the at least one receiving element in a feedback control circuit, through which the transmitting power of the transmitting elements is varied by branch with the aim of regulating the light output of the beams received by the receiving element and emitted by the at least one transmitting element of the first transmitting branch and reflected at the outside of the optically permeable body to be the same as the light power of the reflected beams received by the receiving element sent out by the at least one transmitting element of the second transmitting branch; and
before operation of the sensor storing initial values for control signals for the transmitting elements are stored and during operation of the sensor determining a static deviation from the difference between the current values for the control signals and the initial values.

9. A memory element for a control unit of a sensor for detecting dirt and/or moisture on an optically permeable body on which a computer program is stored for performing a method in accordance with claim 8.

10. A control unit for a sensor for detecting dirt and/or moisture on an optically permeable body having a computer, specifically a microprocessor, and a memory element, wherein the sensor has several optical transmitting elements and at least one receiving element and the transmitting elements are combined into at least two transmitting branches, which, together with the at least one receiving element, are connected in a feedback control circuit which varies the transmitting power of the transmitting elements by branch with the aim of regulating the light output of the beams received by the receiving element, emitted by the at least one transmitting element of the first transmitting branch (A) and reflected at the outside of the optically permeable body to be the same as the light output of the reflected beams received by the receiving element, emitted by the at least one transmitting element of the second transmitting branch, characterized in that the control unit has means for storing initial values for control signals for the transmitting elements before operation of the sensor and means for determining static deviation during operation of the sensor from the difference between the current values for the control signals and the initial values.

11. The control unit as set forth in claim 10, wherein a computer program is stored on the memory element which can be run on the computer and is suitable for executing a procedure in accordance with claim 8.
